(19) United States
(12) Patent Application Publication
(10) Pub. No.: US 2016/0059164 A1
(43) Pub. Date: Mar. 3, 2016

(54) FLUID INLET SCREEN BEING MOVEABLE TO BYPASS POSITION

(71) Applicant: Hamilton Sundstrand Corporation, Windsor Locks, CT (US)

(72) Inventor: Mark R. Plickys, Unionville, CT (US)

(21) Appl. No.: 14/475,850

(22) Filed: Sep. 3, 2014

(51) Int. Cl. B01D 35/147; B01D 29/00; B01D 35/02

(52) U.S. Cl. CPC B01D 35/1475; B01D 35/02; B01D 29/0097

(57) ABSTRACT

A fluid filter assembly comprises an outer housing, a filter element including a face, and a filter portion extending from the face. The housing has an inlet and an outlet. A spring biases the face against a housing structure at the inlet. A pressure drop across the filter assembly biases the filter element against the spring force such that if the pressure drop exceeds the spring force, the filter element can move to a bypass position. A hydraulic system is also disclosed.

### STATEMENT REGARDING FEDERALLY SPONSORED RESEARCH OR DEVELOPMENT

This invention was made with government support under Contract No. N00019-08-G-0002XT23, awarded by the United States Navy. The Government has certain rights in this invention.

### BACKGROUND OF THE INVENTION

This application relates to a fluid filter that is moveable to a bypass position under certain conditions.

Hydraulic systems are known and, typically, include a hydraulic supply supplying a fluid to a pump. The pump moves the hydraulic fluid for various uses. It is known to provide a filter associated with an inlet to the pump to remove metal debris, etc. from the hydraulic fluid before it reaches the pump.

Known filters for use in hydraulic systems have typically included a fixed filter element. Under certain conditions, the filter can result in a very high pressure drop that can be detrimental to a pump.

### SUMMARY OF THE INVENTION

A fluid filter assembly comprises an outer housing, a filter element including a face, and a filter portion extending from the face. The housing has an inlet and an outlet. A spring biases the face against a housing structure at the inlet. A pressure drop across the filter assembly biases the filter element against the spring force such that if the pressure drop exceeds the spring force, the filter element can move to a bypass position. A hydraulic system is also disclosed.

These and other features may be best understood from the following drawings and specification.

### BRIEF DESCRIPTION OF THE DRAWINGS

FIG. 1 shows a filter element in a standard position.

FIG. 2 shows a filter element having moved to a bypass position.

FIG. 3 is a cross-sectional view along line 3-3 of FIG. 1.

### DETAILED DESCRIPTION

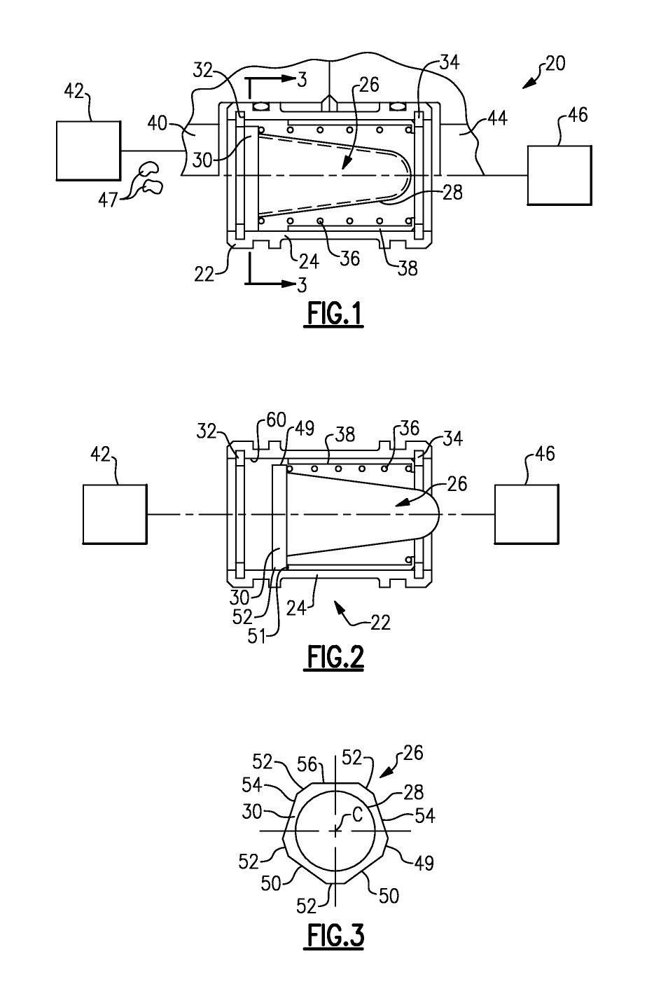

A hydraulic system 20 is illustrated in FIG. 1. A filter assembly 22 includes an outer housing 24. A filter element 26 is received within housing 24 and has a frusto-conical forward filter portion 28 and a rear face 30. Retainer rings 32 and 34 retain the filter element 26 and a spring 36 within the housing 24. A spring retainer 38 further serves to properly position the spring 36. As shown, the spring 36 acts against the face 30 and biases the filter element 22 against the ring 32.

In the position shown in FIG. 1, the filter element 26 is in the path of fluid flowing from a tube 40 to a tube 44. The tube 40 receives hydraulic fluid from a source 42 and the tube 44 communicates with a pump 46.

As shown, particles 47 may be in this fluid flow, and in the FIG. 1 position the fluid all flows through the filter element 26. Thus, the particles 47 will be prevented from reaching the pump 46.

While a pump 46 is disclosed, any number of other components may also benefit from such a filter. As an example, contamination sensitive devices such as orifices, close tolerance vales, etc., will benefit from the filter element. The filter element may be part of a component known as a “jumper tube” or “transfer tube” and serves to connect two components within a hydraulic system.

The force from spring 36 is sufficient to hold the filter element 26 in this position during most operational conditions.

However, under cold conditions and, in particular, at startup, the pressure drop imposed across filter assembly 22 may be high and may be detrimental to the operation of pump 46.

Thus, as shown in FIG. 2, under those conditions, the pressure on the face 30 may be sufficient to move the filter 26 against the force of the spring 36 and allow the fluid to flow around the outer periphery 49 of the face 30.

As shown in FIG. 2, an end 51 of the spring guide or retainer 38 provides a stop that is abutted by the face 30 in this position. Particles may move around the outer periphery 49, however, the time the filter spends in this position is limited.

Once the fluid heats, the pressure will drop and the spring 36 will again move the filter 26 back to the FIG. 1 position.

As shown in FIG. 3, the outer periphery 49 of the face 30 includes a plurality of flats 50, 52, 54 and 56. These flats allow the spring to pivot somewhat while moving and further provide flow passages for allowing the flow when the filter 26 is in the FIG. 2 position.

Portions 52 of the flats are formed further outwardly from a center point C than are portions 56, 54, and 50. The portions 56, 54 and 50 form fluid passages while the portions 52 generally form pivot points for guiding the spring element 26 during movement. As an example, and as shown in FIG. 2, a pivot point 52 is in contact with an inner surface 60 of the outer housing 24. While the outer periphery 49 is shown to have a particular set of flats, in embodiments, the ability to bypass flow may be achievable by other non-cylindrical shapes.

Although an embodiment of this invention has been disclosed, a worker of ordinary skill in this art would recognize that certain modifications would come within the scope of this invention. For that reason, the following claims should be studied to determine the true scope and content of this invention.

1. A fluid filter assembly comprising:
an outer housing, a filter element including a face, and a filter portion extending from the face, the housing having an inlet and an outlet, and a spring biasing said face against a housing portion at said inlet; and
a pressure drop across said filter assembly biasing said filter element against a force of said spring such that if the pressure drop exceeds the spring force, the filter element can move to a bypass position.

2. The fluid filter assembly as set forth in claim 1, wherein a retainer ring provides said housing portion.

3. The fluid filter assembly as set forth in claim 1, wherein said filter portion has a generally frusto-conical shape.

4. The fluid filter assembly as set forth in claim 1, wherein said face has a non-cylindrical outer periphery.

5. The fluid filter assembly as set forth in claim 4, wherein said non-cylindrical shape includes a plurality of flats.

6. The fluid filter assembly as set forth in claim 5, wherein said plurality of flats include a first group of flats spaced further from a center of said filter element, and providing a pivot points within said outer housing, and a second set of flats spaced closer to said center of said filter element to provide flow passages when said filter element is in said bypass position.

7. The fluid filter assembly as set forth in claim 1, wherein a spring retainer is positioned between said spring and said outer housing, and said spring retainer providing a stop for said spring element when it is in said bypass position.

8. A hydraulic system comprising:
a source of hydraulic fluid communicating into an inlet of a filter assembly, and a component pump connected to an outlet of said fluid filter assembly;
the fluid filter assembly having an outer housing, a filter element including a face and a filter portion extending from the face, the housing having an inlet and an outlet, and a spring biasing said face against housing portion at said inlet; and
a pressure drop across said filter assembly biasing said filter element against a force of said spring such that if the pressure drop exceeds the spring force, the filter element can move to a bypass position.

9. The hydraulic system as set forth in claim 8, wherein a retainer ring provides said housing portion.

10. The hydraulic system as set forth in claim 8, wherein said filter portion has a generally frusto-conical shape.

11. The hydraulic system as set forth in claim 8, wherein said face has a non-cylindrical outer periphery.

12. The hydraulic system as set forth in claim 11, wherein said non-cylindrical shape includes a plurality of flats.

13. The hydraulic system as set forth in claim 12, wherein said plurality of flats include a first group of flats spaced further from a center of said filter element, and providing a pivot points within said outer housing, and a second set of flats spaced closer to said center of said filter element to provide flow passages when said filter element is in said bypass position.

14. The hydraulic system as set forth in claim 8, wherein a spring retainer is positioned between said spring and said outer housing, and said spring retainer providing a stop for said spring element when it is in said bypass position.

15. The hydraulic system as set forth in claim 8, wherein said component is a pump.
